(19) United States
(12) Patent Application Publication
(10) Pub. No.: US 2023/0177873 A1
(43) Pub. Date: Jun. 8, 2023

(54) Authentication Method Based On Anonymous Biometrics Algorithms

(71) Applicant: Svort, Inc., Wilmington, DE (US)

(72) Inventors: Viktar Shulhat, Mogilev (BY); Valery Vashkinel, Kolchuny (BY)

(21) Appl. No.: 17/552,307

(22) Filed: Dec. 15, 2021

Related U.S. Application Data
(63) Continuation of application No. PCT/IB2021/061226, filed on Dec. 2, 2021.

(51) Int. Cl. G06V 40/16; G06V 10/82; G06V 10/54; G06V 10/24; G06N 3/02; H04L 9/32

(52) U.S. Cl. CPC G06V 40/168; G06V 40/172; G06V 10/82; G06V 10/54; G06V 10/245; G06V 40/165; G06N 3/02; H04L 9/3252; H04L 9/3231; G06V 2201/07

(57) ABSTRACT

A computer implemented authentication method comprising the following steps:
determining the spatial position of the user's face using the image obtained by the device's camera;
determining a circumference circumscribed around the user's face and displaying it in the user interface;
determining the horizontal and vertical lines passing through the center of the circumference characterizing the turn of the user's face;
performing at least two rotation user checks comprising the following steps:
   determining a point on the circumference circumscribed around the user's face and displaying it in the user interface;
   prompting the user to change the position of the face so the line intersection point is aligned with the set point;
   obtaining an image of the user's face during the check;
determining the correlation between the model generated on the basis of the user's face images during the rotation checks and the previously generated authorized user parameter-based model.

### CROSS REFERENCE TO RELATED APPLICATION

The present application is a continuation of PCT/IB2021/061226, filed on Dec. 2, 2021, entitled “Authentication method based on anonymous biometrics algorithms,” which is incorporated by reference herein in its entirety.

### TECHNICAL FIELD

This technical solution relates to the art of computer technology, and particularly to systems and methods of face authentication and protection against fraud during such authentication.

### BACKGROUND

Presently, the issues of information security, including authentication, are among pressing topics that invite attention of many researchers. Use of standard authenticity verification methods, such as passwords (text or picture-based) and SMS are often unsafe, especially when used in critical services like those provided by banks, medical or government administration systems etc. This encourages developers to research new methods of authentication. Use of biometric data is one of the development directions of means of authentication.

Accordingly, there is a need for systems and methods with which a user's identity can be verified conveniently, seamlessly, and with a sufficient degree of accuracy, from biometric information captured from the user using readily available smartphones.

### SUMMARY

A method of generating a parameter-based model of an authorized user comprising the following steps (FIG. 1 and FIG. 6):
obtaining a set of images of the user's face in order to generate a model of the authorized user using the user's device (601), and subsequently sending it to the server (602);
processing the obtained images at the server (602);
extracting, using a pre-trained machine learning model, the embedding vector from the obtained face image set at the server (602);
generating the user key using a random or pseudo-random procedure at the server (602);
creating, at the server (602), the topology of an artificial not-fully-connected multilayer perceptron neural network. its number of inputs is equal to the dimension of the embedding vector, and the number of outputs is equal to the dimension of the generated user key;
transforming, at the server (602), of the neural network by way of adding new layers and connections between layers so that in the process of validation of the neural network using an image of the authorized user the output of the neural network is identical to the generated user key whereas if an image of a different user is used, the output is not equal to the generated user key;
encrypting, at the server (602), the embedding vector using the generated key;
determining, at the server (602), the hash value of the key;
saving the embedding vector, the transformed neural network and the hash value based on the generated user key at the server (602) or on the user's device (601).

In certain embodiments user device comprising: a camera, RAM, at least one CPU, ROM or other storage device (HDD, SSD, SD etc.)

In certain embodiments server comprising: RAM, at least one CPU, ROM or other storage device (HDD, SSD, SD etc.)

A computer implemented method of generating a parameter-based model of an authorized user comprising the following steps:
obtaining, by the processor a set of images of the user's face in order to generate the model of the authorized user;
processing, by the processor said set of images;
extracting, by the processor using a pre-trained machine learning model, embedding vectors from the said processed image set;
generating, by the processor a user key using a random or pseudo-random procedure;
forming the topology of a not-fully-connected multilayer perceptron neural network with the number of inputs equal to the dimension of the embedding vectors, and the number of outputs
equal to the dimension of said generated user key; transforming, by the processor said neural network by way of adding new layers and connections between layers so that in the process of validation of the neural network using an image of the authorized user the output of the neural network is identical to the generated user key whereas if an image of a different user is used, the output is not equal to the generated user key;
encrypting, by the processor said embedding vectors using said key;
determining, by the processor hash value of said key;
storing, by the processor the embedding vectors, the transformed neural network and the hash of the generated user key.

A computer implemented authentication method comprising the following steps:
determining, by the processor the spatial position of the user's face at the user's device using the image obtained by the device's camera;
determining, by the processor at the user's device, a circumference circumscribed around the user's face and displaying it in user interface;
determining, by the processor the horizontal and vertical lines passing through the center of the circumference characterizing the turn of the user's face;
performing, by the processor at least two rotation user checks at the user's device that comprising the following steps:
   determining coordinates of the server-generated point on the circumference circumscribed around the user's face, and displaying the circumference in the user interface;
   prompting the user by the user's device to change the position of face so that the coordinates of the point of line intersection are aligned with the coordinates of the point obtained from the server;
   sending, in the process of the check, the image of the user's face from the user's device to the server;
receiving, by the processor at user's device, the result of the check performed by the server of the correlation between the model generated on the basis of the user's face images during the rotation checks and the previously generated authorized user parameter-based model.

A computer implemented authentication method comprising the following steps:
determining, by the processor the spatial position of the user's face using the image obtained by the device's camera;
determining, by the processor a circumference circumscribed around the user's face and displaying it in the user interface;
determining, by the processor the horizontal and vertical lines passing through the center of the circumference characterizing the turn of the user's face;
performing, by the processor at least two rotation user checks comprising the following steps:
   determining, by the processor a point on the circumference circumscribed around the user's face and displaying it in the user interface;
   prompting, by the processor the user to change the position of the face so that the line intersection point is aligned with the set point;
   obtaining, by the processor an image of the user's face during the check;
determining, by the processor the correlation between the model generated on the basis of the user's face images during the rotation checks and the previously generated authorized user parameter-based model;

A system for authenticating a user according to the user's biometric features, comprising:
a user device having a camera, a processor, RAM, memory, the processor configured to:
   determining the spatial position of the user's face at the user's device using the image obtained by the device's camera;
   determining (at the user's device) a circumference circumscribed around the user's face and displaying it in user interface;
   determining the horizontal and vertical lines passing through the center of the circumference characterizing the turn of the user's face;
   performing at least two rotation user checks that comprising the following steps:
      determining coordinates of the server-generated point on the circumference circumscribed around the user's face, and displaying the circumference in the user interface;
      prompting the user to change the position of face so that the coordinates of the point of line intersection are aligned with the coordinates of the point obtained from the server;
      sending, in the process of the check, the image of the user's face to the server;
   receiving the result of the check performed by the server of the correlation between the model generated on the basis of the user's face images during the rotation checks and the previously generated authorized user parameter-based model;

These and other aspects, features, and advantages can be appreciated from the accompanying description of certain embodiments of the invention and the accompanying drawing figures and claims.

### BRIEF DESCRIPTION OF THE DRAWINGS

Details, characteristics and benefits of the technical solution result from the following description of the variants of the technical solution implementation using figures, which show:

FIG. 1: flowchart showing an example of generating a parameter-based model of an authorized user process;

FIG. 2: flowchart showing an example of authentication process;

FIG. 3: determination of the spatial position of the user's face;

FIG. 4: generated point aligned with the intersection of lines;

FIG. 5: rotational checks;

FIG. 6: interaction of a user's device and a server.

Following items are indicated in the figures with numbers:

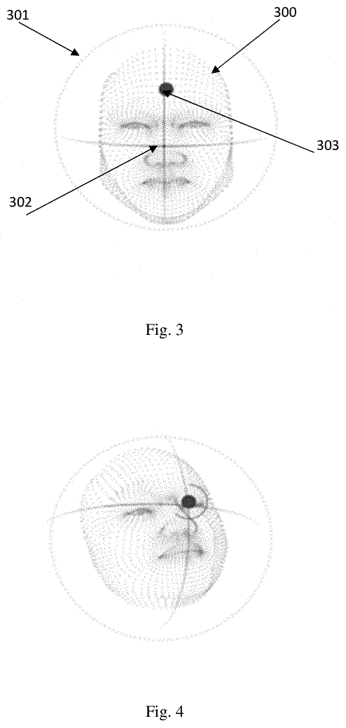

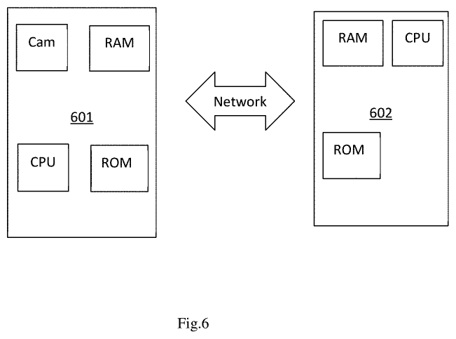

300—user's head, see FIG. 3; 301—circumference around the user's face; 302—center of line intersection; 303—generated point; 601—user's device, see FIG. 6; 602—server.

### DETAILED DESCRIPTION

Certain illustrated explanations of embodiments of the technical solution are presented below.

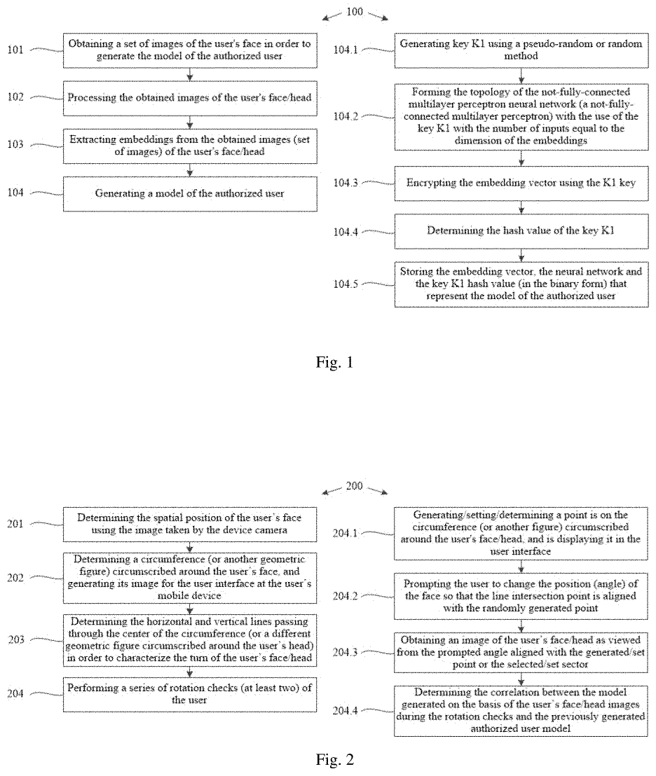

Step 101 (FIG. 1): obtaining a set of images of the user's face in order to generate the model of the authorized user.

In certain embodiments, the number of the used images of the user's face/head depends on the (required) accuracy of recognition at various angles and/or the complexity of checks/the degree of security, and may vary within the range of 5 (one central image and four sectors) up to 721 (one central image+360*2 sectors).

In certain non-limiting embodiments, the user's face/head image is obtained using a photo- or video camera, e.g., one built into a mobile device (a smartphone, tablet etc.).

In certain embodiments, the user's face/head image is generated (obtained, collected) as follows:

a single image of the user's face/head is obtained as a front view (facing exactly forward) and X images—from perspectives other than the front view. Perspectives other than the front view are arranged in a certain circumference having sectors of about 360/X degrees (the center angle of a sector is 360/X degrees). In certain embodiments, two or more circumferences are used, with the radius of each following circumference larger than the radius of the preceding one. The user is instructed to position themselves within the given angles of each sector. The process involves a symbolic arrow drawn from the nose of the user at the coordinates of 0,0 which needs to be positioned within the sector when facing exactly forward.

Certain embodiments use 21/41 images and 9-degree sectors.

In certain embodiments, the user's face is displayed by graphic interface (at the user's mobile device) with a circumference drawn around it and divided into sectors, as well as prompts/instructions to be followed.

In certain embodiments, the user is prompted/instructed to turn their face consequently toward each sector.

In certain embodiments, the user is prompted/instructed to turn their face consequently toward a random sector.

In certain embodiments, the user is prompted/instructed to turn their face consequently toward a specific sector.

In certain embodiments, the user's face/head position is detected at the client (e.g., by a mobile device) and/or the server side (at a server).

In certain embodiments, the use of the GPU (or special CPU, for example, neural processors) is applicable at both the client and/or the server

Certain embodiments use algorithmic and/or mathematical models to determine the position of the user's face/head.

Certain embodiments use pre-trained machine learning models to determine the position of the user's face/head.

In certain embodiments, the step 101 is carried out at the user's mobile device.

In certain embodiments, the step 101 is carried out at a server whereas the user's mobile device is used to display the above graphics only.

Step 102: processing the obtained images of the user's face/head.

In certain embodiments, for each image a clipping/cropping of the image is performed (everything but the user's face/head is removed).

In certain embodiments, the position of the user's face/head is aligned with the forward plane.

In certain embodiments, the scene behind the user's face/head is removed.

In certain embodiments, the user's hair is clipped/removed.

In certain embodiments, the step 102 is carried out at the server.

In certain embodiments, the step 102 is carried out at the user's mobile device.

Step 103: extracting embeddings from the obtained images (set of images) of the user's face/head.

The images obtained during step 101 are used to retrieve embedding vectors.

At the input of the pre-trained model, images of the user's face/head are fed; and embedding vectors are outputted.

An embedding is a vector of values not subject for human interpretation which is obtained with the use of a pre-trained neural network by face recognition applications.

In certain embodiments, to retrieve embeddings, pre-trained machine learning models or machine learning technologies are used, e.g., Deep Face Recognition, Deep Convolutional Neural Networks (DCNN) or Siamese networks.

In certain embodiments FaceNet may be used.

In certain embodiments, TripletLoss or ArcFace may be used as the loss function.

In certain embodiments, the step 103 is carried out at the server.

In certain embodiments, the step 103 is carried out at the user's mobile device.

Step 104: generating a model of the authorized user by way of performing the following steps (actions):

Step 104.1: producing (generating) key K1 (the sequence of data bits used as the key) using a pseudo-random or random procedure.

In certain embodiments, the key may be defined by external means or by the user.

Step 104.2: forming the topology of the not-fully-connected multilayer perceptron neural network (a not-fully-connected multilayer perceptron) with the use of the key K1 with the number of inputs equal to the dimension of the embeddings. For the first iteration, the number of additional layers between the input and the output layers is set to zero. The number of connections is minimum one each for the input and output layers. The number of outputs is equal to the dimension of the key generated previously. Weights are set so that a neuron would produce stable correct values of the key bit for the authorized user (output of one neuron=one key bit), and random values for an unauthorized user. Biases are set so that outputs for an unauthorized user have the same probability (white noise). All these values are calculated based on the set of parameter vectors of the authorized user and unauthorized users during the same one iteration.

After the topology of the neural network has been established, the process of training/transformation of the neural network is carried out.

Neural network training/transformation is carried out with the use of the set of data of the user images, synthetic images and images of other persons.

If the training/transformation process was successful, the trained neural network is saved.

Training/transformation is deemed successful (the success criterion) when in the process of validation, the resulting neural network responds to images that belong to the user (but used during training) with the same pre-generated key, whereas with white noise to any other image.

In the event that training/transformation process was unsuccessful, random connections and intermediate layers are added to the pre-generated neural network. After that, the process of training/transformation is repeated until it results in a success.

Step 104.3: encrypting the embedding vector using the K1 key;

The key outputted by the neural network is used for encryption of the embedding vector whereupon the key itself is deleted (not saved).

Certain embodiments use public-key cryptographic algorithms, such as DSA or ECDSA, to encrypt embeddings.

Step 104.4: determining the hash value of the key K1;

Hashing algorithms may use cryptographic hash-functions sha-1, sha-2, sha-3, md5 or md6 (without limitation).

Step 104.5: storing the embedding vector, the neural network (its topology, weights and biases) and the key K1 hash (in the binary form) that represent the model of the authorized user (a parameter-based 3D model of the user's face/head).

In certain embodiments, the data mentioned at step 104.5 are saved in the memory of the user's device and/or of the server.

In certain embodiments, the data mentioned at step 104.5 are saved in a database or in a file.

The process of user authentication with the use of the created authorized user model (generated as described in steps 101 to 104) will be described later.

In certain embodiments, the step 104 (and all its sub-steps) is carried out at the server.

In certain embodiments, the step 104 (and all its sub-steps) is carried out at the user's mobile device.

Step 201 (FIG. 2): determining the spatial position of the user's face (FIG. 3, 300) using the image taken by the device camera.

In certain non-limiting embodiments, the user's face/head image is obtained using a photo- or video camera, e.g., one built into the mobile device (a smartphone, tablet etc.). Certain embodiments use a fixed camera/external camera, e.g., an ip camera.

In certain embodiments, the detection of the user's face/head position is carried out at the client (e.g., a mobile device) or the server side.

Certain embodiments use algorithmic or mathematical models to determine the position of the user's face/head.

Certain embodiments use pre-trained machine learning models (e.g., those described above) to determine the position of the user's face/head.

In certain embodiments, the step 201 is carried out at the server.

In certain embodiments, the step 201 is carried out at the user's mobile device.

Step 202: determining a circumference (or another geometric figure) circumscribed around the user's face, and generating its image for the user interface (FIG. 3, 301) at the user's mobile device.

In certain non-limiting embodiments, the geometric figure circumscribed around the user's face may be a square, a rhombus, a polygon, a sphere etc.

In certain embodiments, the step 202 is carried out at the user's mobile device.

Step 203: determining the horizontal and vertical lines passing through the center of the circumference (or a different geometric figure circumscribed around the user's head) in order to characterize the turn of the user's face/head.

In certain embodiments, the horizontal and/or vertical lines are displayed in the user interface.

The intersection of the horizontal and vertical lines (FIG. 3, 302) demonstrates to the user the spatial position of their biometric image relative to the camera.

The intersections of the lines (cross-lines) provide the user information on the position of their full-face (attitude angles) in relation to the camera (a visualization of the head turn against zero points).

In certain embodiments, the center of the circumference is tied to the user's full-face, and changes its coordinates as the user's head/face turns.

In certain embodiments, the step 203 is carried out at the user's mobile device.

Step 204: performing a series of rotation checks (at least two) of the user. These checks involve the following steps:

Step 204.1: determining (generating/setting) a point is on the circumference (or another figure) circumscribed around the user's face/head, and is displaying it in the user interface.

In one of embodiments, the point on the circumference may be visualized as shown in FIG. 3, 303.

In certain embodiments, a sector of the circumference circumscribed around the user's face/head is generated/determined, and is displayed in the user interface.

In certain embodiments, two or more circumferences are circumscribed around the user's face/head, with R1<R2< . . . <Rn, where R1 is the radius of the first circumference, R2 is the radius of the circumference circumscribed around the circumference R1 etc.

In certain embodiments, the point/sector is selected randomly.

In certain embodiments, the selection of the point/sector is carried out with consideration of what view angles of the user's face/head were used in the generation of the authorized user model.

Step 204.2: prompting the user to change the position (angle) of the face so that the line intersection point is aligned with the randomly generated point.

In certain embodiments, prompts or information on how to change the position of face/head are displayed to the user.

In certain embodiments, the process of rotation of the user's face/head is recorded as a video recording (is stored at the user's device and/or at a server).

Step 204.3: Obtaining an image of the user's face/head as viewed from the prompted angle aligned with the generated/set point or the selected/set sector.

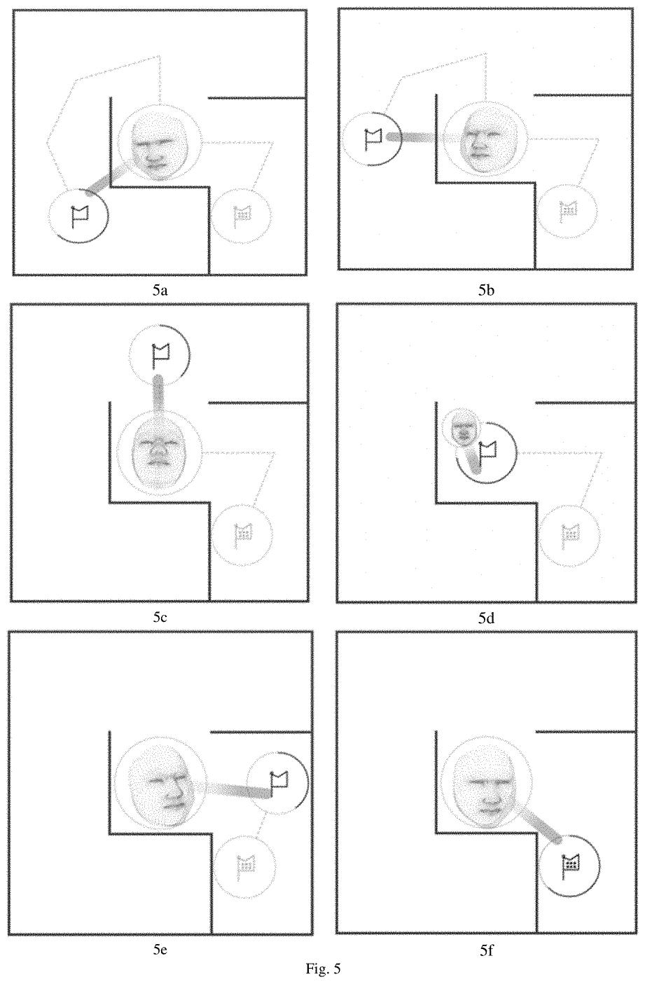

As an example, FIG. 3 shows the initial position of the user's head 300, with the center of line intersection 302 and the generated point 303. In order to perform the check, the user needs to turn their face/head so that the center of intersection of lines 302 is aligned with the generated point 303 (FIG. 4).

Step 204.4: determining the correlation between the model generated on the basis of the user's face/head images during the rotation checks and the previously generated authorized user model.

In certain embodiments, the step 204.4 is carried out after the completion of all rotation checks using all the obtained images.

In certain embodiments, the correlation as per step 204.4. is performed during each rotation check.

The described above previously generated embeddings, neural network and hash value of the key K1 used during training encrypted with the use of the key K1 obtained/generated during the creation of the user model are used as the authorized user model.

The images of the user's face/head obtained during the rotation checks are converted into embeddings, and after that they are fed at the input of the saved neural network, which outputs key K2. Following that, a hash value is generated using the key K2 and is compared with the saved hash value of the key K1. If the hash values agree, the key K2 is used to decrypt the saved embeddings. Following that, the decrypted embeddings are compared (their correlation is determined) with the embeddings obtained on the basis of the user images during rotation checks. In certain embodiments, cosine similarity measure is used to compare (determine the correlation between) embeddings.

In case if the resulting correlation is above a certain value (this value is determined individually depending on the requirements to the system in terms of admissible values of errors of the first and the second kind), the user is authenticated.

In certain embodiments, after the rotation checks are completed and corresponding user face/head images are obtained, the following additional checks are performed:
determination of the texture (the texture of a “live” face is different from the texture of a face expressed on paper or in plaster);
determination of scene edges—abrupt variations in the color range are identified to enable the detection of nonrelevant objects within the scene whose color content differs from the rest of the scene;
determination of face edges;
detection of the moire effect—this enables high accuracy identification of an image demonstrated on-screen;
detection of reflections (the reflective properties of the face itself, as well as specks on the skin and eyes, are determined).

The results of the additional checks affect user authentication, and are taken into consideration during such user authentication. An invalid result of such check may result in authentication failure or, alternatively, the process of rotational and/or additional checks may be repeated (started again).

In certain embodiments, rotational checks may be performed as described below. By way of an example, user authentication may require traversing a certain arbitrary labyrinth wherein repeated rotation checks are passed by way of controlling the process of passage by changing the spatial position of the face relative to the plane of the used camera. The user sees the labyrinth and the sector which needs to be pointed at with a conventional line (FIG. 5a-f) which starts at the nose, and then held in a certain position for a short period of time (up to several seconds). The line may extend and rotate depending on the position of the head relative to the plane of the device's camera.

In certain embodiments, the step 204 is carried out at the server.

In certain embodiments, the step 204 is carried out at the user's mobile device.

At this juncture, it should be noted that although much of the foregoing description has been directed to systems and methods for authenticating a user according to the user's biometric features, the systems and methods disclosed herein can be similarly deployed and/or implemented in scenarios, situations, and settings far beyond the referenced scenarios.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the term's “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items. It is to be understood that like numerals in the drawings represent like elements through the several figures, and that not all components and/or steps described and illustrated with reference to the figures are required for all embodiments or arrangements.

Thus, illustrative embodiments and arrangements of the present systems and methods provide a computer implemented method, computer system, and computer program product for authenticating a user according to the user's biometrics. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

We claim:

1. A computer implemented method of generating a parameter-based model of an authorized user comprising the following steps:
obtaining, by the processor a set of images of the user's face in order to generate the model of the authorized user;
processing, by the processor said set of images;
extracting, by the processor using a pre-trained machine learning model, embedding vectors from the said processed image set;
generating, by the processor a user key using a random or pseudo-random procedure;
forming the topology of a not-fully-connected multilayer perceptron neural network with the number of inputs equal to the dimension of the embedding vectors, and the number of outputs equal to the dimension of said generated user key;
transforming, by the processor said neural network by way of adding new layers and connections between layers so that in the process of validation of the neural network using an image of the authorized user the output of the neural network is identical to the generated user key whereas if an image of a different user is used, the output is not equal to the generated user key;
encrypting, by the processor said embedding vectors using said key;
determining, by the processor hash value of said key;
storing, by the processor the embedding vectors, the transformed neural network and the hash of said generated user key.

2. The method of claim 1, wherein pre-trained machine learning model is Deep Convolutional Neural Network or Siamese network.

3. The method of claim 1, wherein for encrypting DSA or ECDSA is used.

4. A computer implemented authentication method comprising the following steps:
determining, by the processor the spatial position of the user's face using the image obtained by the device's camera;
determining, by the processor a circumference circumscribed around the user's face and displaying it in the user interface;
determining, by the processor the horizontal and vertical lines passing through the center of the circumference characterizing the turn of the user's face;
performing, by the processor at least two rotation user checks comprising the following steps:
determining, by the processor a point on the circumference circumscribed around the user's face and displaying it in the user interface;
prompting, by the processor the user to change the position of the face so that the line intersection point is aligned with the set point;
obtaining, by the processor an image of the user's face during the check;
determining, by the processor the correlation between the model generated on the basis of the user's face images during the rotation checks and the previously generated authorized user parameter-based model;

5. The method of claim 4, wherein after the rotation checks are completed, the following additional checks are performed:
determination of the texture;
determination of scene edges;
determination of face edges;
detection of the moire effect;
detection of reflections.

6. A system for authenticating a user according to the user's biometric features, comprising:
a user device having a camera, a processor, RAM, memory, the processor configured to:
determining the spatial position of the user's face at the user's device using the image obtained by the device's camera;
determining (at the user's device) a circumference circumscribed around the user's face and displaying it in user interface;
determining the horizontal and vertical lines passing through the center of the circumference characterizing the turn of the user's face;
performing at least two rotation user checks that comprising the following steps:
determining coordinates of the server-generated point on the circumference circumscribed around the user's face, and displaying the circumference in the user interface;
prompting the user to change the position of face so that the coordinates of the point of line intersection are aligned with the coordinates of the point obtained from the server;
sending, in the process of the check, the image of the user's face to the server;
receiving the result of the check performed by the server of the correlation between the model generated on the basis of the user's face images during the rotation checks and the previously generated authorized user parameter-based model;

7. The system of claim 6, wherein after the rotation checks are completed, the following additional checks are performed:
determination of the texture;
determination of scene edges;
determination of face edges;
detection of the moire effect;
